(19) United States
(12) Patent Application Publication
(10) Pub. No.: US 2003/0158774 A1
(43) Pub. Date: Aug. 21, 2003

(54) Product information offering device and a program thereof

(75) Inventor: Yutaka Katsuyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/338,842

(22) Filed: Jan. 9, 2003

(30) Foreign Application Priority Data
Feb. 18, 2002 (JP) 2002-039996

(51) Int. Cl. G06F 17/60

(52) U.S. Cl. 705/10

(57) ABSTRACT

A product information offering device that determines that a consumer purchased a product based on product information received by the consumer. A product information offering device records a product inquiry by a consumer. The received and recorded inquiry is compared to the product sales information of a store, and thus a judgment can be made that the consumer purchased the product and the purchase was based on the product information received.

### CROSS-REFERENCE TO RELATED APPLICATIONS

This Application is based on, and claims priority to, Japanese Application 2002-039996, filed Feb. 18, 2002 in Japan, and which is incorporated by reference herein

### BACKGROUND OF THE INVENTION

1. Field of the Invention

The present invention relates to an electronic purchasing system. More particularly, the present invention provides an apparatus, method, and computer readable storage that can recognize that a consumer who is offered information regarding a product actually purchases the product.

2. Description of the Related Art

Currently, conducting commerce over the Internet is very common. There are many web sites that provide a range of product information on the Internet. For example, see Japanese Patent 2001-84272, entitled “A method and device to search for specific information related to an obtained object identifier” that provides a range of product information to users over the Internet. Many such web sites allow consumers who access the sites to obtain product information free of charge, and the operational costs and profit of the web site are provided from advertising revenue.

However, in recent times, the viability of the previous model has been questioned, because there are so many websites offering content and related advertising. Thus, advertising income derived from a web site providing content is decreasing.

A web site can provide content and charge a fee to the consumers who are accessing the website to obtain product information. However, there are currently many websites that provide free product information, and it is difficult to obtain income by charging users for access to content or product information.

### SUMMARY OF THE INVENTION

It is an aspect of the invention to provide a new and improved sales system that does not contain the disadvantages of the models discussed above.

The present invention provides for a product information offering device, a method, and a computer readable storage thereof that allows a website to provide product information about a product to a consumer and to determine whether the consumer buys the product (from a different party) as a result of the consumer viewing the information.

The present invention allows the product information offering device to recognize the fact that a consumer purchased a product as a result of the consumer referring to information received from the website with product information. As a result, the website using the product information offering device of the present invention can present data confirming that providing product information led to actual sales performance, thus allowing the obtaining of a sales promotional fee from the manufacturer of the product.

The above aspects can be attained by a system that includes (a) an inquiry information storage means that records inquiry information about product information by consumers; (b) a sales information recording means that receives and records sales information for the products at a store; and (c) an information comparison means that compares the inquiry information stored in the inquiry information storage means, and the sales information stored in the sales information recording means.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram illustrating the principles of the present invention, according to an embodiment of the present invention;

FIG. 2 is a schematic diagram of the present invention, according to an embodiment of the present invention;

FIG. 3 is a block diagram illustrating an example of a data structure of the inquiry information, product information, pathogen information, sales information, store information and the inquiry/sales performance information, according to an embodiment of the present invention;

FIG. 4 is an internal structure diagram of the product information offering device, according to an embodiment of the present invention;

FIG. 5 is a flowchart of a method used by the inquiry information generation program, according to an embodiment of the present information;

FIG. 6 is an illustration of an example of a display for an information terminal, according to an embodiment of the present invention;

FIG. 7 is an illustration of an example of a display for an information terminal, according to an embodiment of the present invention;

FIG. 8 is a flowchart of a method used by the sales program, according to an embodiment of the present invention;

FIG. 9 is a flowchart of a method used by the inquiry/sales performance information generation program, according to an embodiment of the present invention;

FIG. 10 is a block diagram illustrating an example of the data structure for inquiry information, product information, sales information, pathogen information, sales information, store information and the inquiry sales performance information, according to an embodiment of the present invention;

FIG. 11 is a flowchart of a method used by the sales program, according to an embodiment of the present invention; and

FIG. 12 is a flowchart of a method used by the inquiry/sales performance information generation program, according to an embodiment of the present invention.

### DETAILED DESCRIPTION OF THE PREFERRED EMBODIMENTS

The present invention uses a product information offering device and a sales management computer. The product information offering device communicates with the sales management computer of a store that sells the product, recognizes the fact that the product in the product information offered to the consumer was sold, and thus make a judgment that the consumer purchased the product based on the offered product information.

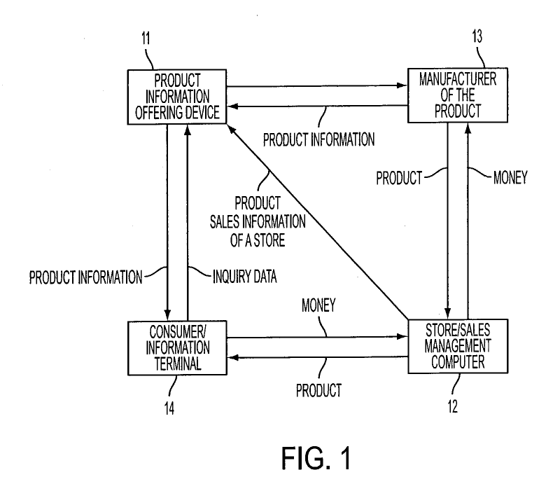

FIG. 1 is a block diagram illustrating the principles of the present invention, according to an embodiment of the present invention.

The product information offering device 11 obtains product information from the manufacturer 13 of the product. The product information offering device 11 offers the information regarding to product to the consumer/information terminal 14, in response to an inquiry by the consumer/information terminal 14. At this time, the product information offering device 11 records inquiry data that is a record of what kind of product information was obtained by the consumer/information terminal 14. When the consumer/information terminal 14 visits the store/sales management computer 12 and actually purchases the product of the inquiry, the product information offering device 11 receives product sales data that comprises information about the purchasing of the product from the store/sales management computer 12.

As a result of making a comparison between the inquiry data and product sales data, it can be determined that the consumer/information terminal 14 purchased the product because of the information offered by the product information offering device 11. The product information offered by the product information offering device 11 does not have to be supplied by the manufacturer 13, but can also be supplied by the manager of the product information offering device 11 and store/sales management computer 12. The product information can be comprised of information obtained from a multiplicity of consumers/information terminals 14. The program information offering device 11 can transmit data representing that sales of a product are directly connected to inquiries for that product to the manufacturer of the product 13.

An example embodiment illustrates a case in which a consumer with a particular allergic symptom purchases a product without the allergen.

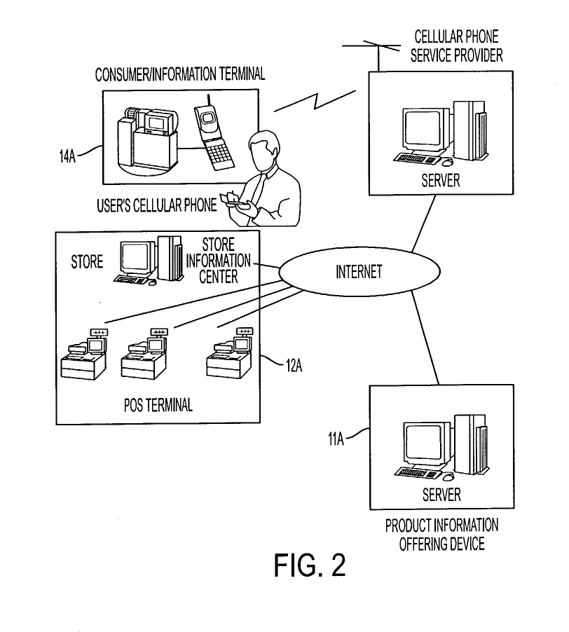

FIG. 2 is a schematic diagram of the present invention, according to an embodiment of the present invention.

Consumers typically operate web-connectable portable information terminals and connect to a variety of servers via the server of a mobile phone service. Consumer/information terminal 14a can display a variety of information on the LCD of a portable information terminal and can transmit data input from the portable information terminal to the server. The product information offering device 11a is a computer server connected to a computer communications network such as the Internet and offers information to the information terminal regarding the product by being operated by the information terminal that communicates via the Internet. Thus by communicating with the store/store information center/POS terminals 12a, information about the sales of the product at the store can be obtained.

A first embodiment of the present invention is described as follows.

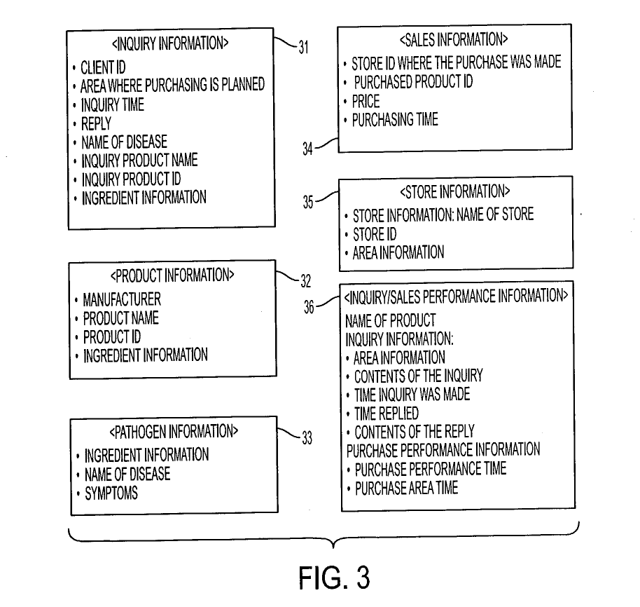

FIG. 3 is a block diagram illustrating an example of a data structure of the inquiry information 31, product information 32, pathogen information 33, sales information 34, store information 35 and the inquiry/sales performance information 36, according to an embodiment of the present invention.

The inquiry information 31 is generated by the product information offering device 11 when a consumer/information terminal 14 communicates with the product information offering device 11 and makes an inquiry about a product.

Product information 32 can comprise a variety of information about the product offered by the product information offering device 11, and the product information 32 is stored in the product information offering device 11 in advance, that is, before the consumer/information terminal 14 makes an inquiry about the product to the product information offering device 11.

Pathogen information 33 is a record for the allergen, its symptoms and the name of the disease, and the record is recorded in the product information offering device 11 in advance of an inquiry. Inquiry information 31 is created by referring to the product information 32 and pathogen information 33 from the inquiry given by the consumer/information terminal 14.

Sales information 34 is recorded in store/sales management computer 12 when the consumer/information terminal 14 purchases the product at the store/sales management computer, and is transmitted to the product information offering device 11.

Store information 35 relates to the location of each store/sales management computer 12 and is stored in the product information offering device 11 in advance.

Inquiry sales performance information 36 is created from the inquiry information 31, sales information 34 and store information 35.

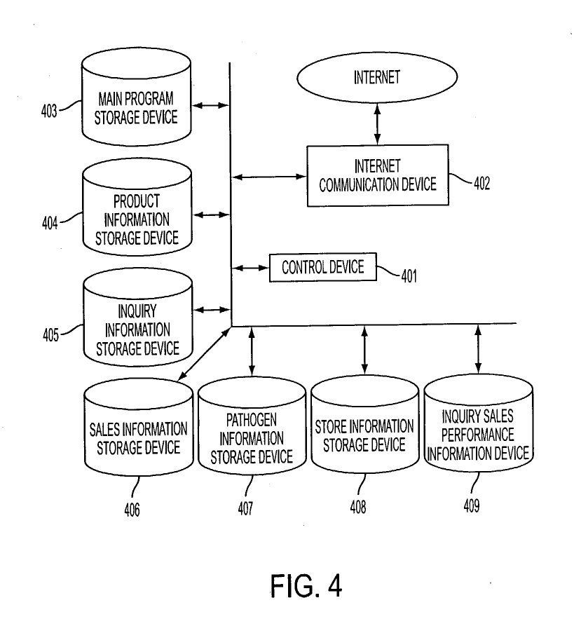

FIG. 4 is an internal structure diagram of the product information offering device, according to an embodiment of the present invention.

Control device 401 executes a program that controls the product information offering device 11. It can compare and search through a variety of information. Internet communication device 402 communicates with sales management computer 12 and information terminal 14 via the Internet. Main program storage 403 stores a program executed by the control device 401. Product information device 404 stores a multiplicity of product information 32. Inquiry information storage device 405 stores a multiplicity of inquiry information 31. Sales information storage device 406 stores a multiplicity of sale information 34 that is transmitted from the store/sales management computer 12. Pathogen information storage device 407 stores a multiplicity of pathogen information 33. Store information storage device 408 stores a multiplicity of store information 35. Inquiry sales performance storage device 409 stores a multiplicity of sales performance information 36.

Creation of the inquiry information 31 is carried out through controlling the input/output of consumer/information terminal 14 using an inquiry information generation program for the product information offering device 11.

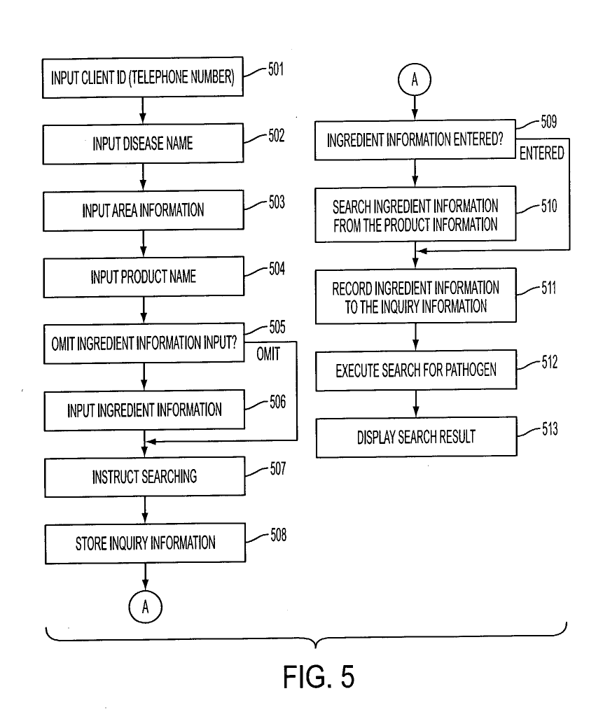

FIG. 5 is a flowchart of a method used by the inquiry information generation program, according to an embodiment of the present information.

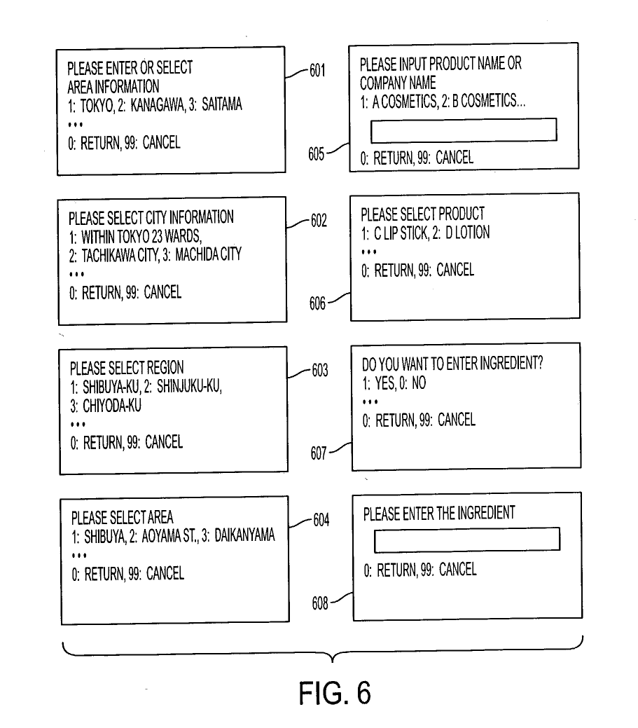

FIG. 6 is an illustration of an example of a display for an information terminal, according to an embodiment of the present invention.

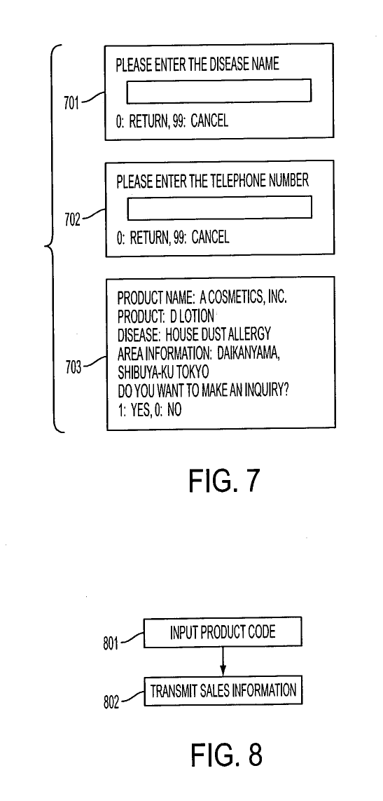

FIG. 7 is an illustration of an example of a display for an information terminal, according to an embodiment of the present invention.

More particularly, FIGS. 6 and 7 show the input/output screen when inquiry information 31 for the consumer/information terminal 14 is being created.

The product information offering device 11 displays a telephone number input screen 703 on the consumer/information terminal 14, and prompts for the entering of a telephone number as the client ID. The product information offering device 11 stores the input as the client ID (telephone number) for the actual inquiry. (operation 501)

The product information offering device 11 displays a disease name input screen 701 on the consumer/information terminal 14, and prompts for the entering of the name of a disease that is of concern. The product information offering device 11 stores the input as the name of the disease (operation 502). The product information offering device 11 also can optionally display a telephone number input screen 702, which prompts for an input of a telephone number.

The product information offering device 11 displays area information input screens 601, 602, 603 and 604 on the consumer/information terminal 14 and prompts for the entering of the area information where purchasing is planned. The product information offering device 11 stores the input as the area where the purchasing is planned (operation 503).

The product information offering device 11 displays product name input screens 605 and 606 on the consumer/information terminal 14 and prompts for the entering of the product name that is planned to be purchased. The product information offering device 11 stores the input as the product name. In addition, by referring to the product sales information 32 with the product name, the product ID of the product can be found (operation 504).

The product information offering device 11 displays ingredient input screens 606 and 607 on the consumer/information terminal 14 and prompts for the entering of an ingredient, if a consumer wants to avoid some ingredient. The product information offering device 11 stores the input as the ingredient information (operations 505 and 506). The entering of this ingredient information can be entered or omitted (screen 608).

The product information offering device 11 displays an inquiry confirmation screen 703 on the consumer/information terminal 14, and prompts for a confirmation as to whether to execute the inquiry about the product (operation 507).

The product information offering device 11 stores the entered inquiry from the consumer/information terminal 14 as inquiry information 31 in the inquiry information storage 405 (operation 508).

In the event the ingredient to be avoided by the consumer was not entered at operations 505 and 506, ingredients to be avoided are found from the name of the disease by searching with the name of the disease that was entered at operation 502 in the pathogen information 33 stored in the pathogen information storage 407 (operations 509 and 510).

Ingredient information that should be avoided by the consumer is stored in the inquiry information 31 (operation 511).

When product information 32 stored in the product information storage 404 is searched with the product name for which an inquiry, in the inquiry information 31, was received, the ingredient information that comprises the product under the product name is found. If this ingredient information and the ingredient information that should be avoided by the consumer as input in the inquiry information 31 are identical, the fact that the ingredient that should be avoided by the consumer is contained in the product of the inquiry in the inquiry information 31 is found. If they are not identical, then the fact that there should be no problem from purchasing this product by the consumer is found (operation 512).

The product information offering device 11 displays the result of operation 512 on the consumer/information terminal 14. The time of this inquiry is stored in the inquiry information 31 (operation 513).

FIG. 8 is a flowchart of a method used by the sales program, according to an embodiment of the present invention.

A consumer purchases a product at a store based on the information about a product obtained from operation 513. When the product is actually sold, the store/sales management computer 12 stores the product ID, the period of the sale, and the store ID of the store where the purchase was made as the sales information 34 (operation 801).

The store/sales management computer 12 transmits this sales information 34 to the product information offering device 11 (operation 802). The transmission can be made for each sale or the transmission can be made every time certain multiple sales are made.

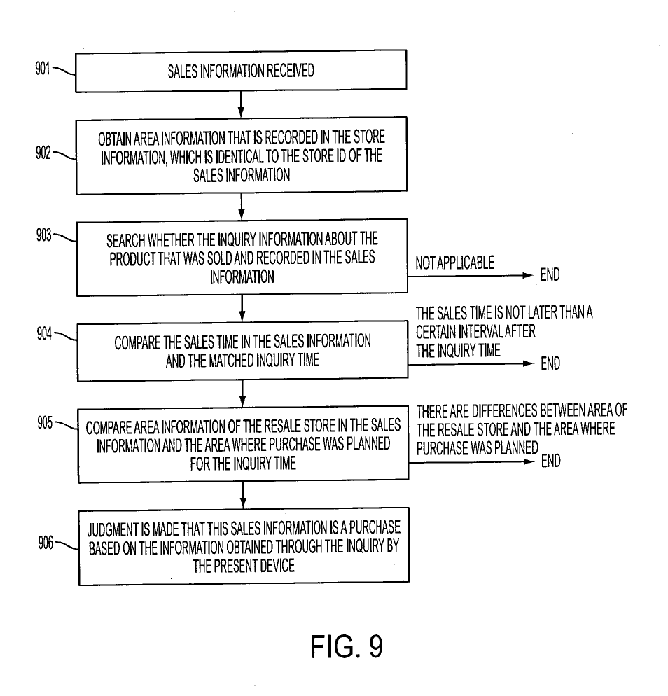

FIG. 9 is a flowchart of a method used by the inquiry/sales performance information generation program, according to an embodiment of the present invention. This flowchart shows single sales information.

During operation 802, the product information offering device 11 receives sales information 34 transmitted from the store/sales management computer 12, and stores it in the sales information storage 406. (operation 901)

Store information 35 containing the store ID recorded in the sales information 34 received during operation 901 is searched for in the store information storage 408. Area information from the sales information 34 can be obtained from the identical store information 35 (operation 902)

Inquiry information 31 with an identical inquiry product ID to the product ID that is purchased, which was recorded in the sales information 34 received during operation 901, is searched for in the inquiry information storage 405. If there is a match, it is recognized that the product of inquiry received by the product information offering device 11 was actually sold at the store/sales management computer 12 (operation 903).

The inquiry time of the multiple inquiry information 31 that was compared and matched during operation 903, and the time of purchase in the sales information 34 are compared. If there is an inquiry information 31 that is prior to the time of purchase in the sales information 34, as well as within a certain inquiry time, it is determined that said product was actually sold at the store/sales management computer 12 after the product information offering device 11 was inquired of by the consumer/information terminal 14 (operation 904)

A comparison is made between the area for which the purchase was planned in the multiple inquiry information 31 that was compared and matched in operation 904, and the area information for the store where the purchase was made in the sales information 34 searched in operation 902. If these areas are identical, it is determined that said product for which an inquiry was received by the product information offering device 11 from the consumer/information terminal 14, was purchased in the area for which purchasing was planned by the consumer/information terminal 14 (operation 905).

If an inquiry information 31 in which the sales information 34 received by the product information offering device 11 meets the conditions during operations 904 and 905, then it can be determined that a consumer/information terminal 14 made a purchase at the store/sales management computer 12 using the inquiry information 31 offered by the product information offering device 11. Information/sales performance information 36 is created from the inquiry information 31 that matches conditions for sales information 34, received by the product information offering device (operation 906).

In this embodiment, the area where the purchase is planned to take place and the area information for the store where the purchase is made are compared during operation 905, after the inquiry time and purchase time are compared during operation 904. However, the order of these comparisons can be reversed, and in addition, carrying out either one of the comparisons instead of both is also possible.

A second embodiment of the invention will now be described. In the first embodiment, the consumer/information terminal 14 did not make any input that specifies the identity during the purchase of the product at the store/sales management computer 12. However, in this second embodiment, a telephone number is entered in the store/sales management computer 12 as the client ID at the time of the product purchase.

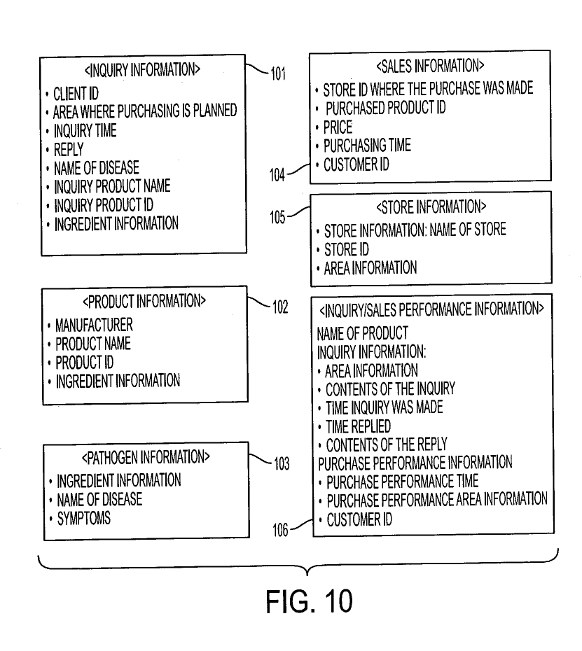

FIG. 10 is a block diagram illustrating an example of the data structure for inquiry information 101, product information 102, and pathogen information 103, sales information 104, store information 105 and the inquiry sales performance information 106, according to an embodiment of the present invention.

Inquiry information 101, product information 102, pathogen information 103 and store information 105 have the same structure as inquiry information 31, product information 32, pathogen information 33, and store information 35 in the first embodiment.

Sales information 104 is stored in the store sales management computer 12 when a consumer/information terminal 14 makes the purchase of a product at the store/sales management computer 12, and then is transmitted to the product information offering device 11. The client ID of the client who purchased the product is stored in the sales information 104.

Inquiry sales performance information 106 is created from the inquiry information 31, sales information 104 and store information 105. The client ID of the client who purchased the product is stored in the sales performance information 106.

The internal structural view of the product information offering device 11 of the present embodiment is typically the same as described in the first embodiment.

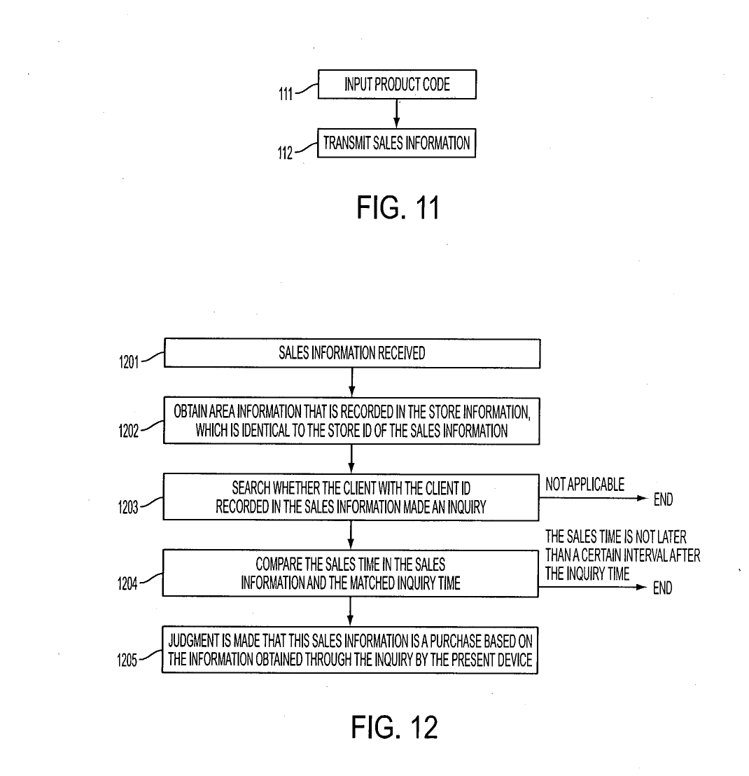

FIG. 11 is a flowchart of a method used by the sales program, according to an embodiment of the present invention. The inquiry information generation program of the product information offering device 11 of the present embodiment is typically the same as the one described in the first embodiment.

A consumer purchases a product at a store based on the product information obtained from operation 513. When the product is purchased, the store/sales management computer 12 enters the telephone number of the client and the product ID of the product purchased, the sales period, the store ID of the store where the purchase is made, and the client ID for the person who made the purchase and stores it as sales information 104 (operation 111).

Store/sales management computer 12 transmits this sales information 104 to the product information offering device 11 (operation 112). It can be transmitted for every sale, and it can be transmitted for every set of multiple sales.

FIG. 12 is a flowchart of a method used by the inquiry/sales performance information generation program, according to an embodiment of the present invention.

The product information offering device 11 receives the sales information transmitted from store/sales management computer 12 during operation 112, and stores it in the sales information storage 406 (operation 1201).

Store information 35 with the store ID where the purchase was made, stored in the sales information 34, received during operation 1201 is searched for in the store information storage 408. The area information of the sales information 34 can be obtained from the identical store information 35 (operation 1202).

Inquiry information 31 with an identical client ID to the client ID stored in the sales information 34, received during operation 1201 is searched for in the inquiry information storage 405. If there is a match, it is determined that the product of the inquiry received by the product information offering device 11 in the inquiry information storage 405 was actually purchased at the store/sales management computer 12 by the consumer/information terminal 14 (operation 1203).

A comparison is made between the inquiry time of the multiple inquiry information 31 that was compared and matched during operation 1203, and the time of purchase. If there is inquiry information 31 with an inquiry time that is prior to the purchase time in the sales information 34, and within a certain period of time, then it is recognized that the consumer/information terminal 14 actually purchased said product at the store/sales management computer 12 after the product information offering device 11 received the inquiry from the consumer/information terminal 14 (operation 1204).

If there is inquiry information 31 in which the sales information 34 received by the product information offering device 11 matches the condition during operation 1204, then it can be recognized that the consumer/information terminal 14 made a purchase at the store/sales management computer 12 with the inquiry information 31 offered by the product information offering device 11. Inquiry/sales performance information 36 is created from the inquiry information 31 that matches the conditions for the sales information 34 received by the product information offering device 11 (operation 1205).

As described above, the product information offering device of the present invention allows recognition of the fact that a purchase was made based on the product information offered.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A product information offering device comprising:
an inquiry information storage means that records inquiry information about product information by consumers;
a sales information recording means that receives and records sales information for the products at a store; and
an information comparison means that compares the inquiry information stored in the inquiry information storage means with the sales information stored in the sales information recording means.

2. A product information offering device described in claim 1 wherein,
said inquiry information contains inquiry time information, said sales information contains product purchasing time, and said comparison means makes a comparison between said inquiry time information and said product purchasing time.

3. A product information offering device described in claim 1 wherein,
said inquiry information contains a purchasing area information with regard to purchasing information, and said sales information contains a store area information with regard to a store of purchase, and said comparison means makes a comparison between said purchasing area and said store area information.

4. A product information offering device described in claim 1 wherein, said inquiry information contains an inquiring client identifier that identifies an inquiry client who made the inquiry, said sales information contains a client identifier for the product purchase that identifies a purchasing client who purchased the product, and said comparison means makes a comparison between said inquiring client identifier and the client identifier for the product purchase.

5. A computer readable storage medium storing a program comprising:
an inquiry information storage means that records inquiry information about product information by consumers,
a sales information recording means that receives and records sales information for the product at a store; and
an information comparison means that makes a comparison between the inquiry information stored in the inquiry information storage means with the sales information stored in the sales information recording means.

6. A product information offering device comprising:
an inquiry information storage device that records inquiry information about product information by consumers;
a sales information recording device that receives and records sales information for the products at a store; and
an information comparison device that compares the inquiry information stored in the inquiry information storage device with the sales information stored in the sales information recording device.

7. A product information offering device as recited in claim 6, wherein,
said inquiry information contains inquiry time information, said sales information contains product purchasing time, and said comparison device makes a comparison between said inquiry time information and said product purchasing time.

8. A product information offering device as recited in claim 6, wherein,
said inquiry information contains a purchasing area information with regard to purchasing information, and said sales information contains a store area information with regard to a store of purchase, and said comparison device makes a comparison between said purchasing area and said store area information.

9. A product information offering device as recited in claim 6, wherein, said inquiry information contains an inquiring client identifier that identifies an inquiry client who made the inquiry, said sales information contains a client identifier for the product purchase that identifies a purchasing client who purchased the product, and said comparison device makes a comparison between said inquiring client identifier and the client identifier for the product purchase.

10. A computer readable storage medium controlling a computer by:
recording product inquiry information about product information by consumers;
recording product sales information for the products at a store; and
determining if a product sale was made in response to a product inquiry by comparing the recorded inquiry information and the recorded sales information.

11. A computer readable storage as recited in claim 10, wherein,
said product inquiry information contains inquiry time information, said sales information contains product purchasing time, and said comparing makes a comparison between said inquiry time information and said product purchasing time.

12. A computer readable storage as recited in claim 10, wherein,
said inquiry information contains a purchasing area information with regard to purchasing information, and said sales information contains a store area information with regard to a store of purchase, and said comparing makes a comparison between said purchasing area and said store area information.

13. A computer readable storage as recited in claim 10, wherein,
said inquiry information contains an inquiring client identifier that identifies an inquiry client who made the inquiry, said sales information contains a client identifier for the product purchase that identifies a purchasing client who purchased the product, and said comparing makes a comparison between said inquiring client identifier and the client identifier for the product purchase.

14. A method, comprising:
recording product inquiry information about product information by consumers;
recording product sales information for the products at a store; and
determining if a product sale was made in response to a product inquiry by comparing the recorded inquiry information and the recorded sales information.

15. A method as recited in claim 14, wherein,
said product inquiry information contains inquiry time information, said sales information contains product purchasing time, and said comparing makes a comparison between said inquiry time information and said product purchasing time.

16. A method as recited in claim 14, wherein,
said inquiry information contains a purchasing area information with regard to purchasing information, and said sales information contains a store area information with regard to a store of purchase, and said comparing makes a comparison between said purchasing area and said store area information.

17. A method as recited in claim 14, wherein,
said inquiry information contains an inquiring client identifier that identifies an inquiry client who made the inquiry, said sales information contains a client identifier for the product purchase that identifies a purchasing client who purchased the product, and said comparing makes a comparison between said inquiring client identifier and the client identifier for the product purchase.

18. An apparatus, comprising:
an information unit providing a consumer with product information in response to a consumer inquiry, and storing inquiry information regarding the inquiry;
a sales unit completing a sales transaction regarding purchase of a product, and storing sales information regarding the transaction; and
a determining unit determining that a sale by the sales unit was a result of information provided by the information unit by comparing the stored inquiry information and the stored sales information.

19. A computer readable storage, controlling a computer by:
providing a consumer with product information in response to a consumer inquiry, and storing inquiry information regarding the inquiry;
completing a sales transaction regarding purchase of a product, and storing sales information regarding the transaction; and
determining that a sale was a result of the providing by comparing the stored inquiry information and the stored sales information.

20. A method, comprising:
providing a consumer with product information in response to a consumer inquiry, and storing inquiry information regarding the inquiry;
completing a sales transaction regarding purchase of a product, and storing sales information regarding the transaction; and
determining that a sale was a result of the providing by comparing the stored inquiry information and the stored sales information.

21. A determining unit, comprising:
a communication unit receiving stored inquiry information regarding a plurality of consumer inquiries, the consumer inquiries provide a consumer with relevant product information;
the communication unit also receiving stored sales information regarding purchases of products; and
a determining unit determining that a sale in the stored sales information was a result of provided product information by comparing the stored inquiry information and the stored sales information.

22. A computer readable storage controlling a computer by:
receiving stored inquiry information regarding a plurality of consumer inquiries, the consumer inquiries provide a consumer with relevant product information;
receiving stored sales information regarding purchases of products; and
determining that a sale in the stored sales information was a result of provided product information by comparing the stored inquiry information and the stored sales information.

22. A method, comprising:
receiving stored inquiry information regarding a plurality of consumer inquiries, the consumer inquiries provide a consumer with relevant product information;
receiving stored sales information regarding purchases of products; and
determining that a sale in the stored sales information was a result of provided product information by comparing the stored inquiry information and the stored sales information.
